(19) United States
(12) Patent Application Publication
(10) Pub. No.: US 2023/0169346 A1
(43) Pub. Date: Jun. 1, 2023

(54) COMPUTER-READABLE RECORDING MEDIUM STORING MACHINE LEARNING PROGRAM, APPARATUS, AND METHOD

(71) Applicant: FUJITSU LIMITED, Kawasaki-shi (JP)

(72) Inventor: Akihiro TABUCHI, Kawasaki (JP)

(73) Assignee: FUJITSU LIMITED, Kawasaki-shi (JP)

(21) Appl. No.: 17/884,603

(22) Filed: Aug. 10, 2022

(30) Foreign Application Priority Data
Nov. 30, 2021 (JP) 2021-194838

(51) Int. Cl. G06N 3/08

(52) U.S. Cl. CPC G06N 3/084

(57) ABSTRACT

A non-transitory computer-readable recording medium stores a machine learning program for causing a computer to execute a process including: allocating processors to each group of one or more layers of a neural network, and causing the processors to execute machine learning by pipeline parallel processing in units of micro-batches obtained by dividing a mini-batch which is one unit of training data used for parameter update of the neural network; and performing setting such that, as a part of backward propagation for each of the micro-batches before the parameter update by each of the processors, backward propagation of a larger number of micro-batches is omitted for a processor allocated to a group of layers closer to an input of the neural network and backward propagation of a smaller number of micro-batches is omitted for a processor allocated to a group of layers closer to an output of the neural network.

### CROSS-REFERENCE TO RELATED APPLICATION

This application is based upon and claims the benefit of priority of the prior Japanese Patent Application No. 2021-194838, filed on Nov. 30, 2021, the entire contents of which are incorporated herein by reference.

### FIELD

The embodiment discussed herein is related to a computer-readable recording medium storing a machine learning program, a machine learning apparatus, and a machine learning method.

### BACKGROUND

Due to an increase in the size of a neural network model (hereinafter, also simply referred to as a “model”), sophistication of AI applications and services is being developed. In the past, machine learning of a model had been executed by arranging the entire model in a memory of one processor. However, there are cases in which a huge model, for example, a model having a large data size (the number of parameters) may not be arranged in a memory, and in such cases, machine learning of a model may not be executed. Accordingly, there is an increasing demand for a technique called “model parallelism” in which one model is divided and arranged in a plurality of processes, and all processes cooperate with each other to train the one model.

U.S. Patent Application Publication No. 2019/0362227 is disclosed as related art.

### SUMMARY

According to an aspect of the embodiments, a non-transitory computer-readable recording medium stores a machine learning program for causing a computer to execute a process including: allocating processors to each group of one or more layers of a neural network, and causing the processors to execute machine learning by pipeline parallel processing in units of micro-batches obtained by dividing a mini-batch which is one unit of training data used for parameter update of the neural network; and performing setting such that, as a part of backward propagation for each of the micro-batches before the parameter update by each of the processors, backward propagation of a larger number of micro-batches is omitted for a processor allocated to a group of layers closer to an input of the neural network and backward propagation of a smaller number of micro-batches is omitted for a processor allocated to a group of layers closer to an output of the neural network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing model parallelism by inter-layer division;

FIG. 2 is a diagram for describing a problem in common pipeline parallel processing;

FIG. 3 is a functional block diagram of a machine learning apparatus;

FIG. 4 is a diagram illustrating comparison between common pipeline parallel processing and the proposed method;

FIG. 5 is a diagram for describing correction of an error gradient in a case where backward propagation is omitted;

FIG. 6 is a block diagram illustrating an overview of the configuration of a computer that functions as the machine learning apparatus;

FIG. 7 is a flowchart illustrating an example of machine learning processing;

FIG. 8 is a diagram illustrating an example of accuracy verification; and

FIG. 9 is a diagram illustrating comparison between common pipeline parallel processing and another example of the proposed method.

### DESCRIPTION OF EMBODIMENTS

The method of model parallelism includes inter-layer division in which a model is divided in units of layers and intra-layer division in which each layer is divided. Inter-layer division is advantageous in that implementation is easy and the amount of communication between divided units is small. On the other hand, the intra-layer division has a drawback that it is difficult to implement and the amount of communication between divided units is large. For a huge model, there are many cases in which inter-layer division is applied. In inter-layer division, pipeline processing is performed in units of micro-batches obtained by dividing a mini-batch of training data.

For example, a technique for executing machine learning of a deep neural network in parallel processing by a pipeline has been proposed. In this technique, a processor is allocated to each group obtained by dividing a deep neural network between layers, and a mini-batch is further divided and pipeline processing is performed. At this time, in this technique, forward propagation and backward propagation of machine learning by each processor are alternately performed, and parameter update processing is independently performed by each processor. Accordingly, this technique reduces the time during which each processor is in a waiting state, and achieves high speed machine learning of a model.

For example, in a case where forward propagation and backward propagation are simply alternately performed as in the related art, there may be processors in a waiting state due to a difference in processing time between forward propagation and backward propagation.

As one aspect, an object of the disclosed technique is to improve the efficiency of machine learning of a model by pipeline parallel processing.

Hereinafter, an example of the embodiment according to the disclosed technique will be described with reference to the drawings.

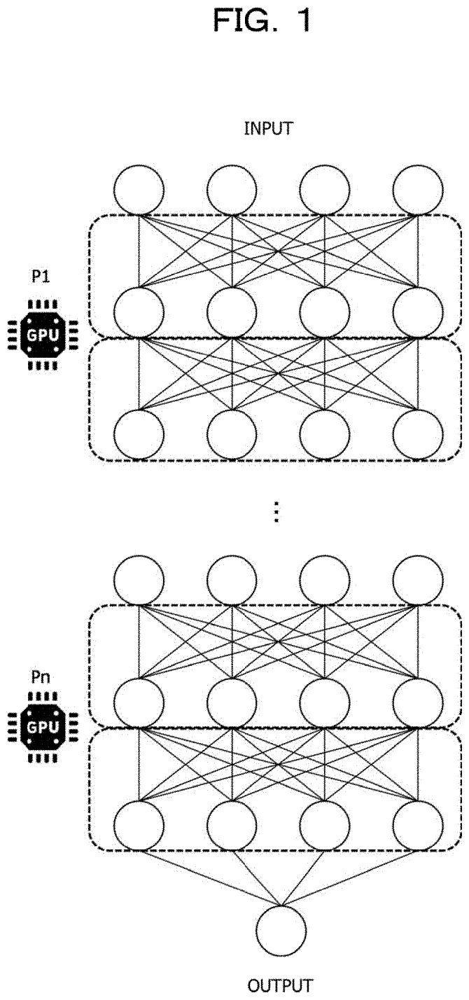

As illustrated in FIG. 1, in the machine learning apparatus according to the present embodiment, a processor is allocated to each group of one or more layers of a neural network that is a model. In the example of FIG. 1, a graphics processing unit (GPU) is illustrated as an example of a processor. In the example of FIG. 1, each portion indicated by a broken line corresponds to one layer. The machine learning apparatus causes the processors to execute machine learning by pipeline parallel processing in units of micro-batches obtained by dividing a mini-batch which is one unit of training data used for parameter update of a neural network. The processing of machine learning includes forward propagation of outputting an inference result for input data and backward propagation of calculating a correction amount (error gradient) for a parameter (weight).

A problem in common model parallelism by inter-layer division will be described by using an example in which pipeline parallel processing is executed by four processors. Numbers 1, 2, 3, and 4 are assigned respectively to the processors in order from a processor allocated to a group of layers close to the input of the model. Hereinafter, a processor with a number n is referred to as a “processor Pn”. A batch of training data used for one time of parameter update is referred to as a mini-batch, and a batch obtained by further dividing the mini-batch is referred to as a micro-batch. In this example, numbers 1, 2, . . . are assigned to the micro-batches in the order of input to the model. Hereinafter, a μb-th micro-batch is referred to as a “micro-batch μb”.

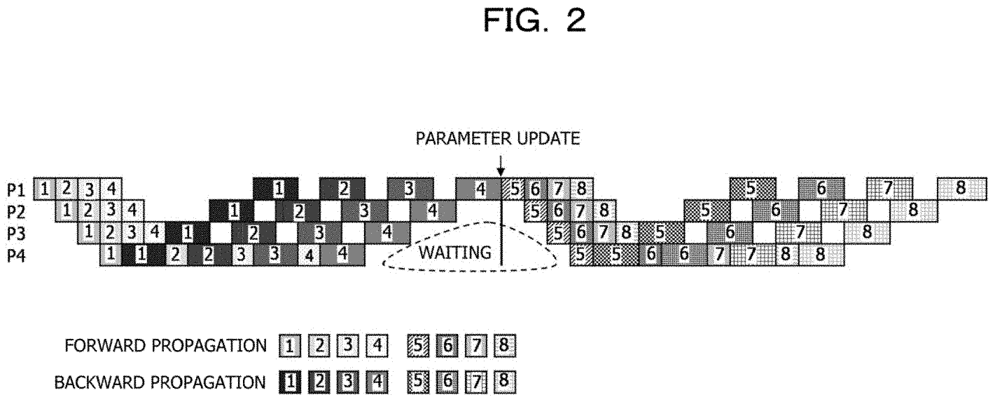

For example, as illustrated in FIG. 2, the first mini-batch is divided into micro-batches 1 to 4, and the next mini-batch is divided into micro-batches 5 to 8. FIG. 2 illustrates micro-batches to be processed by each processor in accordance with the passage of time from left to right. Each block in FIG. 2 corresponds to each micro-batch, and the number in each block is the number assigned to the micro-batch represented by the block.

In common pipeline parallel processing, parameters of layers allocated to each processor are updated based on a parameter update value integrated by averaging the error gradients calculated for each micro-batch in each processor or by other means. For this reason, as illustrated in FIG. 2, before parameter update by the first mini-batch, the processors P2 to P4 wait until backward propagation of the last micro-batch 4 is ended. After parameter update, the processors P2 to P4 wait until the first micro-batch 5 of the next mini-batch is forward propagated. As described above, in common pipeline parallel processing, since a pipeline stops before and after parameter update processing, there is a problem that the waiting time of processors is long and the processing efficiency is poor.

Accordingly, in the present embodiment, backward propagation around parameter update is omitted, and the waiting time of each processor is reduced. Hereinafter, the configuration of a machine learning apparatus 10 according to the present embodiment will be described.

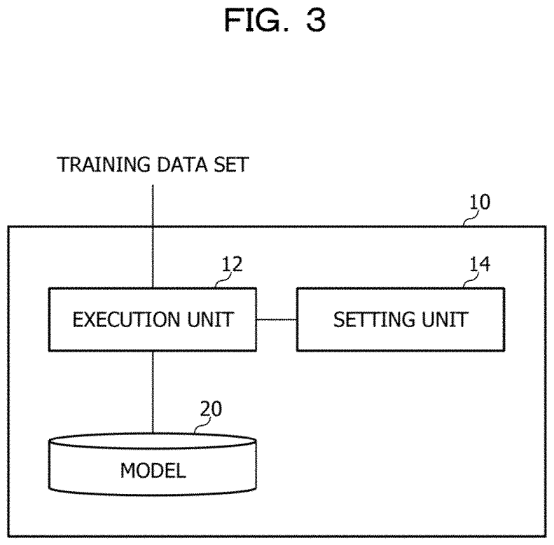

As illustrated in FIG. 3, the machine learning apparatus 10 functionally includes an execution unit 12 and a setting unit 14. A model 20 as a target of machine learning (neural network model) is stored in a predetermined storage area of the machine learning apparatus 10.

The execution unit 12 acquires a training data set input to the machine learning apparatus 10, samples a predetermined number of pieces of training data from the training data set and acquires mini-batches, and divides the mini-batches and acquires a predetermined number of micro-batches. The execution unit 12 sequentially inputs the micro-batches to the model 20, and causes each processor to execute machine learning by pipeline parallel processing.

For example, the execution unit 12 causes each processor to execute forward propagation and backward propagation for each layer included in the group allocated to the processor, thereby calculating an error gradient for each micro-batch. The execution unit 12 causes each processor to independently execute parameter update based on a parameter update value integrated by averaging the error gradients calculated for each micro-batch or by other means.

The setting unit 14 performs setting such that a part of backward propagation for each micro-batch before parameter update by each processor is omitted. For example, the setting unit 14 performs setting such that backward propagation of a larger number of micro-batches is omitted for a processor allocated to a group of layers closer to the input of the model 20 and backward propagation of a smaller number of micro-batches is omitted for a processor allocated to a group of layers closer to the output of the model 20. For example, the setting unit 14 performs setting for each processor of up to what number of micro-batch backward propagation is to be executed based on the number of micro-batches per mini-batch, the total number of processors, and the number assigned to each processor. As described above, the number assigned to each processor indicates the order of the group of layers to which each processor is allocated, from the input side of the model 20.

For example, the setting unit 14 performs setting for a processor Pn to perform parameter update by performing backward propagation up to a micro-batch μb satisfying the following condition.

μb≤n_μb−(n_p−n−0)

n_μb is the number of micro-batches per mini-batch, μb is a number assigned to a micro-batch in a mini-batch (1≤μb≤n_μb), n_p is the total number of processors, and n is a number assigned to a processor (1≤n≤n_p).

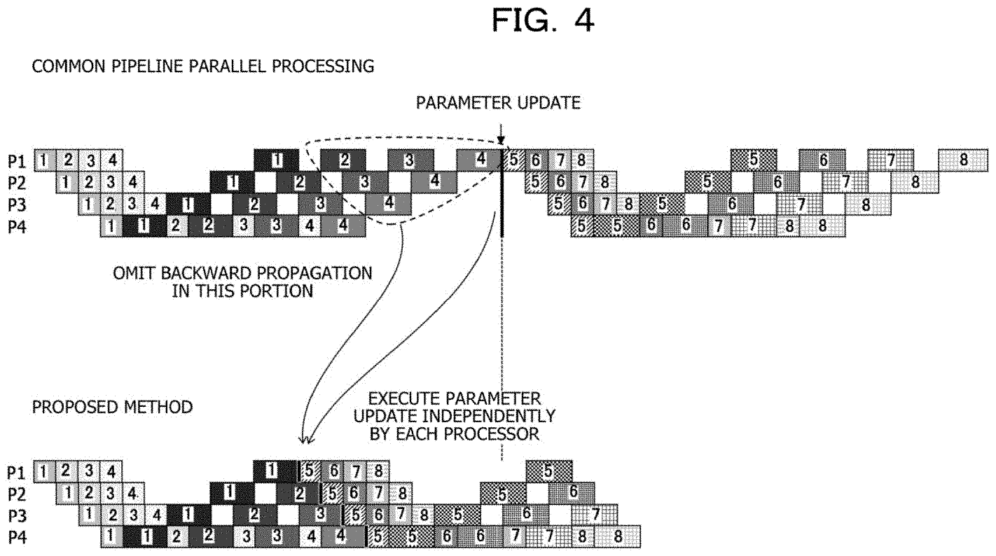

As illustrated in FIG. 4, in a case where pipeline parallel processing is executed by four processors as in the example of FIG. 2, the setting unit 14 performs setting for the processor P1 to execute backward propagation up to the micro-batch 1, for example, to omit backward propagation of the micro-batches 2 to 4. The setting unit 14 performs setting for the processor P2 to execute backward propagation up to the micro-batch 2, for example, to omit backward propagation of the micro-batches 3 and 4. The setting unit 14 performs setting for the processor P3 to execute backward propagation up to the micro-batch 3, for example, to omit backward propagation of the micro-batch 4. The setting unit 14 performs setting for the processor P4 to execute backward propagation up to the micro-batch 4, for example, to execute backward propagation of all the micro-batches.

As described above, since each processor independently executes parameter update processing, each processor executes parameter update processing at a stage where backward propagation up to the micro-batch set by the setting unit 14 has ended. When the parameter update processing in each processor ends, micro-batches for the next mini-batch are sequentially input to the model 20. Accordingly, the method of the present embodiment (proposed method in FIG. 4) may shorten the waiting time of each processor and improve the learning efficiency as compared with common pipeline parallel processing.

A condition for determining the micro-batches on which backward propagation is to be executed is not limited to the above example, and may be changed as appropriate according to the number of micro-batches per mini-batch, the total number of processors, characteristics of training data, and the like. For example, the last “0” in the above condition may be changed to a value larger than 0 (“1”, “2”, “3”, or the like). In this case, the number of micro-batches for which backward propagation is omitted decreases.

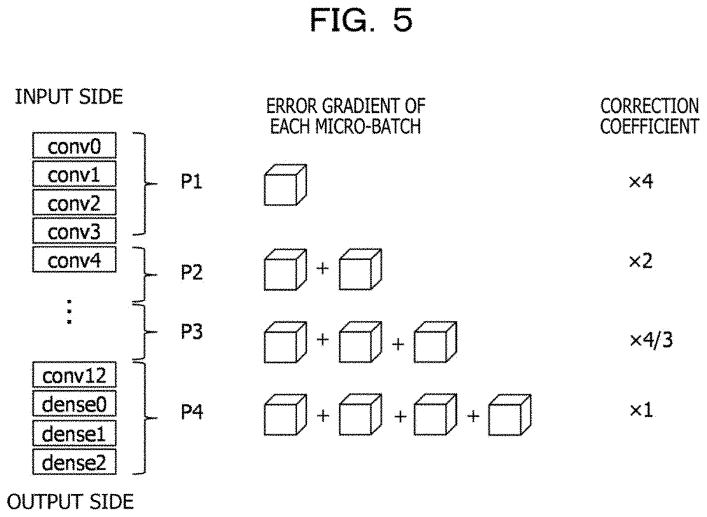

At the time of parameter update, the setting unit 14 receives, from a user, designation of whether to multiply an error gradient by a correction coefficient corresponding to the number of micro-batches for which backward propagation is omitted. When the multiplication of an error gradient by a correction coefficient is designated, the setting unit 14 performs setting so as to update a parameter by multiplying an error gradient by a correction coefficient. For example, as illustrated in FIG. 5, the setting unit 14 may set “the number of micro-batches per mini-batch (n_μb)/the number of micro-batches for which backward propagation is executed” as the correction coefficient for each group of layers allocated to each processor.

The setting unit 14 may set the timing at which the progress of machine learning is equal to or greater than a predetermined value as the application timing of the processing for setting omission of backward propagation described above. The setting unit 14 may set the timing at which an error between an output of the model 20 and a correct answer is equal to or smaller than a designated value as the application timing.

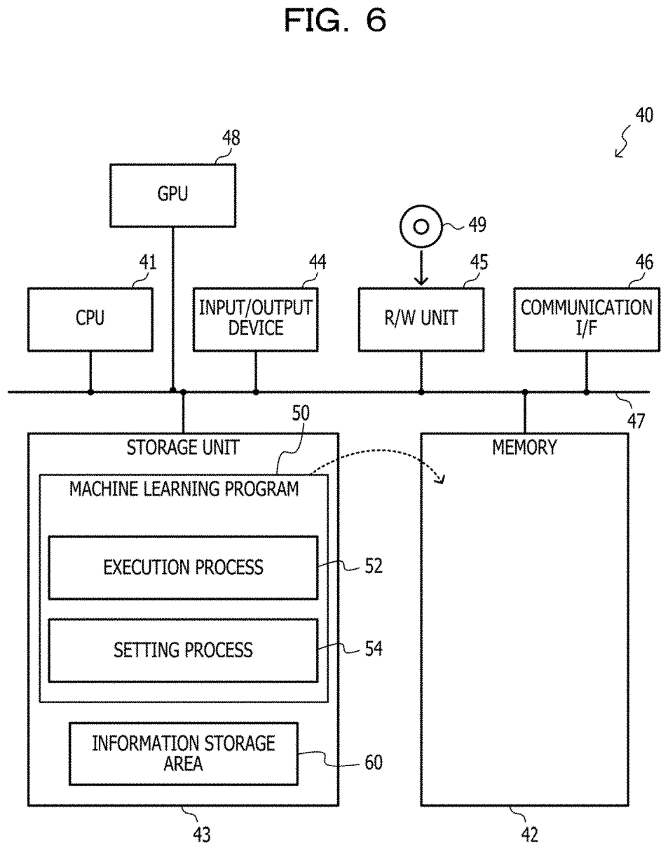

For example, the machine learning apparatus 10 may be realized by a computer 40 illustrated in FIG. 6. The computer 40 includes a central processing unit (CPU) 41, a GPU 48, a memory 42 as a temporary storage area, and a nonvolatile storage unit 43. The computer 40 includes an input/output device 44 such as an input unit, a display unit, and the like and a read/write (R/W) unit 45 that controls reading and writing of data from and to a storage medium 49. The computer 40 includes a communication interface (I/F) 46 that is coupled to a network such as the Internet. The CPU 41, the GPU 48, the memory 42, the storage unit 43, the input/output device 44, the R/W unit 45, and the communication I/F 46 are coupled to each other via a bus 47. The GPU 48 is an example of a processor of the disclosed technique.

The storage unit 43 may be realized by using a hard disk drive (HDD), a solid-state drive (SSD), a flash memory, or the like. The storage unit 43 serving as a storage medium stores a machine learning program 50 for causing the computer 40 to function as the machine learning apparatus 10. The machine learning program 50 includes an execution process 52 and a setting process 54. The storage unit 43 includes an information storage area 60 in which information configuring the model 20 is stored.

The CPU 41 reads the machine learning program 50 from the storage unit 43, loads the read machine learning program 50 into the memory 42, and sequentially executes the processes included in the machine learning program 50. By executing the execution process 52, the CPU 41 operates as the execution unit 12 illustrated in FIG. 3. By executing the setting process 54, the CPU 41 operates as the setting unit 14 illustrated in FIG. 3. The CPU 41 reads information from the information storage area 60, and loads the model 20 into the memory 42. Thus, the computer 40 that has executed the machine learning program 50 functions as the machine learning apparatus 10. The CPU 41 that executes the program is hardware.

For example, the functions realized by the machine learning program 50 may also be realized by a semiconductor integrated circuit, in more detail, an application-specific integrated circuit (ASIC) or the like.

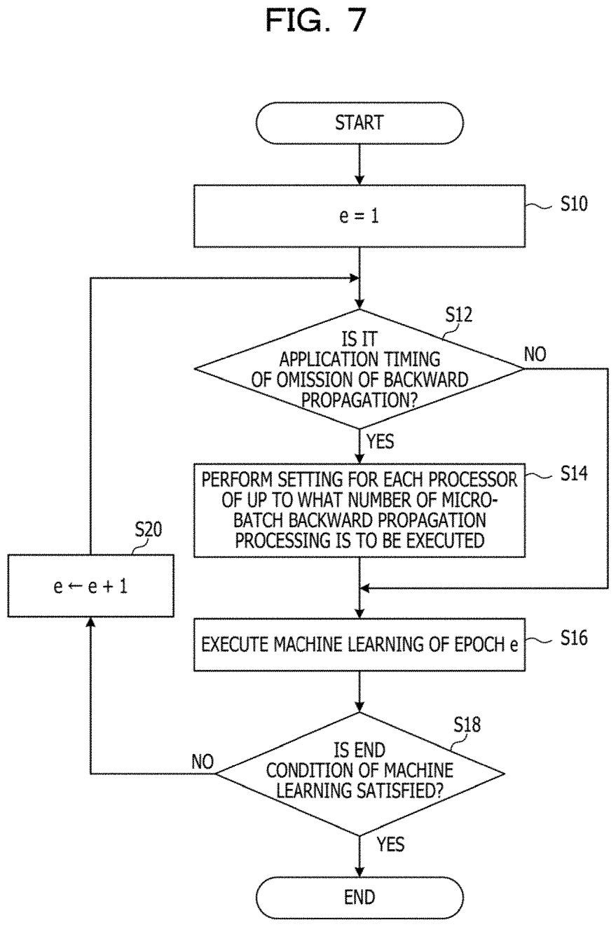

Next, the operation of the machine learning apparatus 10 according to the present embodiment will be described. When a training data set is input to the machine learning apparatus 10 and execution of machine learning is instructed, machine learning processing illustrated in FIG. 7 is executed in the machine learning apparatus 10. Machine learning processing is an example of the machine learning method of the disclosed technique.

In step S10, the execution unit 12 sets 1 for an epoch number e. Hereinafter, an epoch with an epoch number e is referred to as “epoch e”. Next, in step S12, the setting unit 14 determines whether it is the application timing of the processing for setting omission of backward propagation. For example, the setting unit 14 may determine that it is the application timing when the epoch number e is equal to or larger than a designated number, when an error between an output of the model 20 and a correct answer is equal to or smaller than a designated value, or in other cases. When it is the application timing, the processing proceeds to step S14. When it is not the application timing, the processing proceeds to step S16.

In step S14, the setting unit 14 performs setting for each processor of up to what number of micro-batch backward propagation is to be executed based on the number of micro-batches per mini-batch, the total number of processors, and the number assigned to each processor. At this time, the setting unit 14 performs setting such that backward propagation of a larger number of micro-batches is omitted for a processor allocated to a group of layers closer to the input of the model 20 and backward propagation of a smaller number of micro-batches is omitted for a processor allocated to a group of layers closer to the output of the model 20.

Next, in step S16, the execution unit 12 samples a predetermined number of pieces of training data from the training data set input to the machine learning apparatus 10 and acquires mini-batches, and divides the mini-batches and acquires a predetermined number of micro-batches. The execution unit 12 sequentially inputs the micro-batches to the model 20, and causes each processor to execute machine learning of epoch e by pipeline parallel processing. At this time, each processor executes backward propagation up to the micro-batch of the number set in the above step S14, and independently executes parameter update processing at a stage where the backward propagation has ended. For example, each processor omits backward propagation of micro-batches with a number subsequent to the number set in the above step S14. In a case where the setting unit 14 has received designation to correct an error gradient, each processor updates a parameter by multiplying an error gradient by a correction coefficient corresponding to the number of micro-batches for which backward propagation is omitted. In a case where the above step S14 is skipped, for example, in a case where omission of backward propagation is not set, each processor executes backward propagation for all the micro-batches and updates a parameter.

Next, in step S18, the execution unit 12 determines whether an end condition of machine learning is satisfied. For example, an end condition of machine learning may be a case where the epoch number e is equal to or larger than a designated number, a case where an error between an output of the model 20 and a correct answer is equal to or smaller than a designated value, a case where a difference between an error in epoch e−1 and an error in epoch e is equal to or smaller than a designated value, or other cases. When the end condition is not satisfied, the processing proceeds to step S20, the execution unit 12 increments the epoch number e by 1, and the processing returns to step S12. On the other hand, when the end condition is satisfied, the machine learning processing ends.

As described above, the machine learning apparatus according to the present embodiment allocates a processor to each group of one or more layers of a neural network. The machine learning apparatus causes the processors to execute machine learning by pipeline parallel processing in units of micro-batches obtained by dividing a mini-batch which is one unit of training data used for parameter update of a neural network. The machine learning apparatus performs setting such that a part of backward propagation for each micro-batch before parameter update by each of the processors is omitted. At this time, the machine learning apparatus sets the number of micro-batches for which backward propagation is omitted to be larger for a processor allocated to a group of layers closer to the input of the neural network and to be smaller for a processor allocated to a group of layers closer to the output of the neural network. Accordingly, the efficiency of machine learning of a model by pipeline parallel processing may be improved.

The machine learning apparatus according to the present embodiment causes each of the processors to independently execute parameter update at a stage where backward propagation of the set number of micro-batches has ended. Accordingly, the efficiency of machine learning of a model by pipeline parallel processing may be further improved.

The processing time (forward propagation time+backward propagation time) per micro-batch is set as t_μb. In the case of the example illustrated in FIG. 4, in common pipeline parallel processing, the processing time per mini-batch is t_μb×(n_μb+n_p−1), using the number of micro-batches per mini-batch n_μb and the total number of processors n_p. On the other hand, the processing time per mini-batch in the case of the above embodiment is t_μb×n_μb. Accordingly, in the example of FIG. 4, the proposed method makes it possible to increase the processing time by (n_μb+n_p−1)/n_μb times as compared with common pipeline parallel processing. This effect is made larger as the total number of processors increases and as the number of micro-batches per mini-batch decreases.

In the above embodiment, since backward propagation of some micro-batches is omitted, the amount of information on error gradient used for parameter update decreases. For example, there is a larger amount of information on error gradient in a layer close to the input of the model 20. In the example of FIG. 4, for the layer allocated to the processor P1, a parameter is updated based on the information on error gradient of which the amount is larger in the first micro-batch of each mini-batch. However, in practice, the resulting impact is considered to be small. This is based on the fact that, in a neural network, even in the technique of reducing the amount of calculation by gradually stopping the backward propagation operation from the input side layer in which machine learning has sufficiently progressed (Reference 1), accuracy deterioration is hardly seen in a model for which machine learning has been executed.

Reference 1: https://www.fujitsu.com/jp/about/resources/publications/technicalreview/topics/article009.html, “Content-Aware Computing Technology for Speeding up More Complex and Larger Amount of AI Processing”, 3.1 (2) Gradient Skip technology.

The difference between the above technique and the disclosed technique is that, in the above technique, parameter update for a layer on the input side of a model to a layer in which backward propagation is to be stopped is completely stopped, whereas in the disclosed technique, a layer in which backward propagation is to be omitted differs depending on the micro-batch.

An example of a result of verifying the accuracy of the disclosed technique will be described. In this verification, VGG 16 is used as a neural network model, and CIFAR-10 is used as training data. One mini-batch is composed of 128 pieces of training data, and this mini-batch is divided into four micro-batches. For example, one micro-batch is composed of 32 pieces of training data. 16 layers having the parameters of VGG 16 are divided into four groups each including four layers, and the processors P1, P2, P3, and P4 are allocated in order from the group on the input layer side (see FIG. 5).

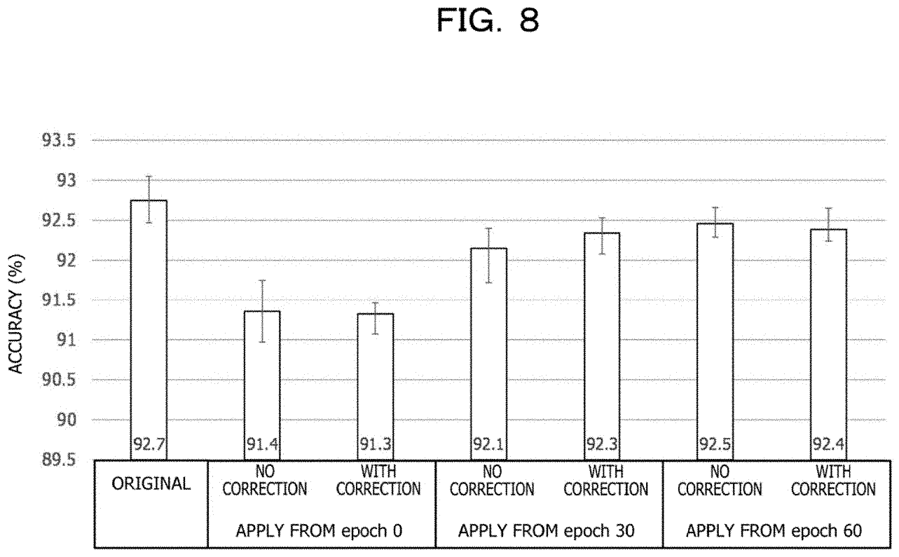

FIG. 8 illustrates an example of the best accuracy (correct answer rate of inference results output by a model) in a case where machine learning is executed up to epoch 200. The accuracy in FIG. 8 is an average for 10 times of learning, and an error range represents a maximum value and a minimum value of the accuracy for 10 times of learning. In FIG. 8, “original” indicates a case where backward propagation is not omitted, and the rest indicate a case where backward propagation is omitted from an epoch with a predetermined number. “With correction” indicates a case where a parameter update value is calculated by multiplying an error gradient calculated for each micro-batch by a correction coefficient as illustrated in FIG. 5, whereas “no correction” indicates a case where an error gradient is not multiplied by a correction coefficient. It may be seen that, even when backward propagation is omitted, there is no large accuracy deterioration compared to original. For example, in a case where omission of backward propagation is applied from epoch 30 or epoch 60, accuracy deterioration is further suppressed and accuracy comparable to that of original is obtained as compared with a case where omission of backward propagation is applied from epoch 0. It has been confirmed that there is a case where accuracy may be improved or variation in accuracy may be suppressed by correcting an error gradient.

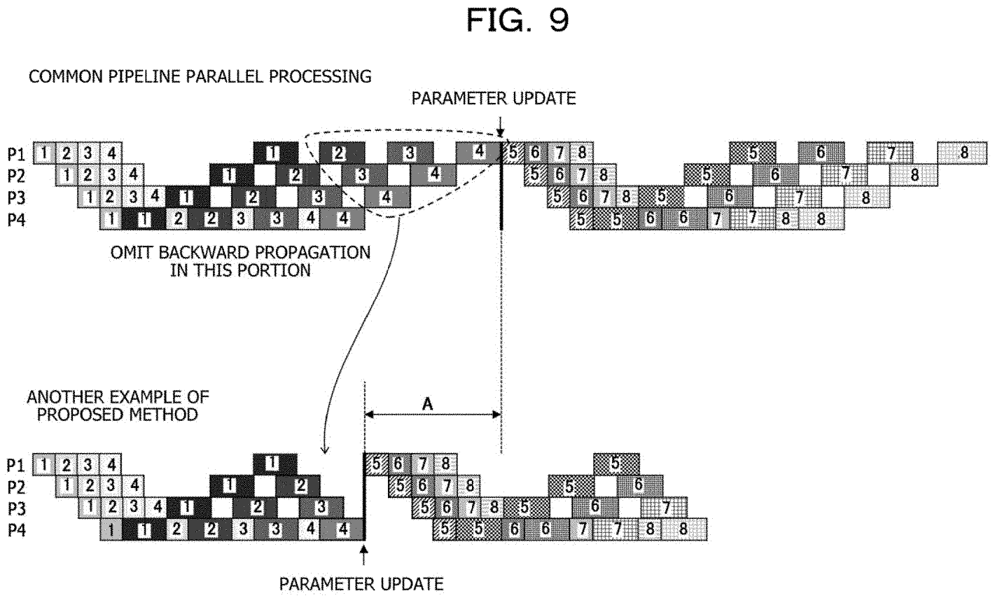

Although the case where each processor is caused to independently execute parameter update has been described in the above embodiment, this is not indispensable. Backward propagation around parameter update may be omitted, and parameter update processing by each processor may be executed at a stage where backward propagation by the processor allocated to the group of layers closest to the output of a neural network has ended. In this case, the waiting time of each processor is longer compared to the case where each processor is caused to independently execute parameter update processing as in the above embodiment. However, as illustrated in FIG. 9, processing time per mini-batch may be shortened as compared with common pipeline parallel processing. For example, the processing time indicated by an arrow A illustrated in FIG. 9 may be shortened.

Although in the above embodiment, a form is described in which the machine learning program is stored (installed) in advance in the storage unit, this is not the only case. The program according to the disclosed technique may also be provided in a form in which the program is stored in a storage medium such as a compact disc read-only memory (CD-ROM), a Digital Versatile Disc (DVD)-ROM, or a Universal Serial Bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process comprising:
allocating processors to each group of one or more layers of a neural network, and causing the processors to execute machine learning by pipeline parallel processing in units of micro-batches obtained by dividing a mini-batch which is one unit of training data used for parameter update of the neural network; and
performing setting such that, as a part of backward propagation for each of the micro-batches before the parameter update by each of the processors, backward propagation of a larger number of micro-batches is omitted for a processor allocated to a group of layers closer to an input of the neural network and backward propagation of a smaller number of micro-batches is omitted for a processor allocated to a group of layers closer to an output of the neural network.

2. The non-transitory computer-readable recording medium according to claim 1,
wherein each of the processors is caused to independently execute the parameter update.

3. The non-transitory computer-readable recording medium according to claim 1,
wherein setting of up to what number of micro-batch backward propagation is to be executed is performed for each of the processors based on a number of micro-batches per mini-batch, a total number of the processors, and an order of a group of layers to which each of the processors is allocated from an input side of the neural network.

4. The non-transitory computer-readable recording medium according to claim 1,
wherein, in the parameter update, a parameter is updated by multiplying an error gradient by a correction coefficient that corresponds to a number of micro-batches for which backward propagation is omitted.

5. The non-transitory computer-readable recording medium according to claim 4,
wherein designation of whether to execute processing of multiplying an error gradient by the correction coefficient is received.

6. The non-transitory computer-readable recording medium according to claim 1,
wherein timing at which progress of the machine learning is equal to or greater than a predetermined value is set as timing at which the performing of setting such that backward propagation is omitted is applied.

7. The non-transitory computer-readable recording medium according to claim 1,
wherein timing at which an error between an output of the neural network and a correct answer is equal to or smaller than a designated value is set as timing at which the performing of setting such that backward propagation is omitted is applied.

8. A machine learning apparatus comprising:
a memory; and
a processor coupled to the memory and configured to:
allocate processors to each group of one or more layers of a neural network, and causing the processors to execute machine learning by pipeline parallel processing in units of micro-batches obtained by dividing a mini-batch which is one unit of training data used for parameter update of the neural network; and
perform setting such that, as a part of backward propagation for each of the micro-batches before the parameter update by each of the processors, backward propagation of a larger number of micro-batches is omitted for a processor allocated to a group of layers closer to an input of the neural network and backward propagation of a smaller number of micro-batches is omitted for a processor allocated to a group of layers closer to an output of the neural network.

9. The machine learning apparatus according to claim 8,
wherein each of the processors is caused to independently execute the parameter update.

10. The machine learning apparatus according to claim 8,
wherein setting of up to what number of micro-batch backward propagation is to be executed is performed for each of the processors based on a number of micro-batches per mini-batch, a total number of the processors, and an order of a group of layers to which each of the processors is allocated from an input side of the neural network.

11. The machine learning apparatus according to claim 8,
wherein, in the parameter update, a parameter is updated by multiplying an error gradient by a correction coefficient that corresponds to a number of micro-batches for which backward propagation is omitted.

12. The machine learning apparatus according to claim 11,
wherein designation of whether to execute processing of multiplying an error gradient by the correction coefficient is received.

13. The machine learning apparatus according to claim 8,
wherein timing at which progress of the machine learning is equal to or greater than a predetermined value is set as timing at which the performing of setting such that backward propagation is omitted is applied.

14. The machine learning apparatus according to claim 8,
wherein timing at which an error between an output of the neural network and a correct answer is equal to or smaller than a designated value is set as timing at which the performing of setting such that backward propagation is omitted is applied.

15. A machine learning method comprising:
allocating processors to each group of one or more layers of a neural network, and causing the processors to execute machine learning by pipeline parallel processing in units of micro-batches obtained by dividing a mini-batch which is one unit of training data used for parameter update of the neural network; and
performing setting such that, as a part of backward propagation for each of the micro-batches before the parameter update by each of the processors, backward propagation of a larger number of micro-batches is omitted for a processor allocated to a group of layers closer to an input of the neural network and backward propagation of a smaller number of micro-batches is omitted for a processor allocated to a group of layers closer to an output of the neural network.

16. The machine learning method according to claim 15,
wherein each of the processors is caused to independently execute the parameter update.

17. The machine learning method according to claim 15,
wherein setting of up to what number of micro-batch backward propagation is to be executed is performed for each of the processors based on a number of micro-batches per mini-batch, a total number of the processors, and an order of a group of layers to which each of the processors is allocated from an input side of the neural network.

18. The machine learning method according to claim 15,
wherein, in the parameter update, a parameter is updated by multiplying an error gradient by a correction coefficient that corresponds to a number of micro-batches for which backward propagation is omitted.

19. The machine learning method according to claim 18,
wherein designation of whether to execute processing of multiplying an error gradient by the correction coefficient is received.

20. The machine learning method according to claim 15,
wherein timing at which progress of the machine learning is equal to or greater than a predetermined value is set as timing at which the performing of setting such that backward propagation is omitted is applied.
